(19) United States
(12) Patent Application Publication
(10) Pub. No.: US 2016/0300076 A1
(43) Pub. Date: Oct. 13, 2016

(54) PRIVACY AUTHORITY MANAGEMENT METHOD AND DEVICE

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventors: Zhong HU, Beijing (CN); Xin WANG, Beijing (CN)

(21) Appl. No.: 15/036,757

(22) PCT Filed: Jul. 17, 2014
(86) PCT No.: PCT/CN2014/082432

§ 371 Date: May 13, 2016

(30) Foreign Application Priority Data
Nov. 15, 2013 (CN) 201310575329.6

(51) Int. Cl. G06F 21/62; G06F 21/50; G06F 21/12

(52) U.S. Cl. CPC G06F 21/6245; G06F 21/126; G06F 21/50

(57) ABSTRACT

Disclosed is a privacy authority management method, including: when a service that needs to use a privacy authority in an operating system is triggered, checking and acquiring information about the service in an application framework layer of the operating system, and notifying an application program layer of the operating system to monitor to the information; after the application program layer of the operating system obtains the information acquired in the application framework layer of the system through monitoring, according to the information, generating an instruction used for managing the service, and transmitting the instruction to the application framework layer of the operating system, so as to command the operating system to manage the service according to the instruction in the application framework layer. The method solves a problem of a technical solution in which a user can manage a privacy authority of an operating system by using third-party security software.

### CROSS-REFERENCE TO RELATED APPLICATIONS

This application is the national stage of International Application No. PCT/CN2014/082432 filed Jul. 17, 2014, which is based upon and claims priority to Chinese Patent Applications No. CN201310575329.6, filed Nov. 15, 2013, the entire contents of which are incorporated herein by reference.

### FIELD OF TECHNOLOGY

The disclosure relates the field of information processing technologies, and in particular to privacy authority management method and device.

### BACKGROUND

Most of security software installed on a mobile device has a function of privacy authority management. By the security software, a user may control an access to core data in a system through other applications in the device and realize some behavior authorities to protect the user's privacy, such as reading call records/texts, sending texts, making a call and opening camera.

Taking Android system as an example, current security software may realize the privacy authority management in a manner of process residence. By allowing dynamic library files of the security software to reside in the system process such as servicemanager and phone in Android, a “hook” is added to an interface where the system read the core data. A callback interface of the security software is invoked. A relevant result is returned according to the user's setting condition, to determine whether to authorize. Only when an authority is achieved, a private data access interface will proceed with the original flow; otherwise be directly omitted.

One of restrictions in the prior art is in that the process residence of the security software requires the user to crack the mobile device to obtain a root privilege. However, this is very difficult for an ordinary user. Further, once the device obtains the root privilege, a risk that a malicious application obtains the top authority to damage the system will be increased. In addition, after-sale services of domestic intelligent mobile device manufacturers exclude the device that has been cracked to obtain the root authority at present. Therefore, the after-sale service of the mobile device having the root privilege also becomes a problem.

In addition, since the manufacturers of Android devices are various and they more or less may modify the system itself, an adaptive problem may occur in some of devices in the prior art.

### SUMMARY

In the view of above problems, the disclosure is proposed to provide a method and a privacy authority management device, for overcoming or at least partially solving above problems.

According to one aspect of the disclosure, there is provided a privacy authority management method, comprising: when a service that needs to use a privacy authority in an operating system is triggered, checking and acquiring information about the service in an application framework layer of the operating system, and notifying an application program layer of the operating system to monitor to the information; and after the application program layer of the operating system obtains the information acquired in the application framework layer of the system through monitoring, according to the information, generating an instruction used for managing the service, and transmitting the instruction to the application framework layer of the operating system, so as to command the operating system to manage the service according to the instruction in the application framework layer.

According to another aspect of the disclosure, there is provided a privacy authority management device, comprising: a privacy service checking unit, configured to, when a service that needs to use a privacy authority in an operating system is triggered, check and acquire information about the service in an application framework layer of the operating system, and notify an application program layer of the operating system to monitor to the information; and a security software unit, configured to, after the application program layer of the operating system obtains the information acquired in the application framework layer of the system through monitoring, according to the information, generate an instruction used for managing the service, and transmit the instruction to the application framework layer of the operating system, so as to command the operating system to manage the service according to the instruction in the application framework layer.

According to the method and the device of the disclosure, a process in the application framework layer of the operating system is used to acquire the service information and to transmit the information to the application of the system application program layer. Since the application itself in the application framework layer of the operating system has the highest authority of the operating system, the information about the service that needs to use the system privacy can be acquired in the application framework layer of the operating system without having to crack the system. By notifying and monitoring, the information and the security software information can be communicated between the application program layer of the operating system and the application framework layer of the operating system, such that applications in the system application program layer can also acquire information by using a normal authority to make a security policy. Thus, the disclosure solves a problem of a technical solution in which a user can manage a privacy authority of an operating system by using third-party security software without having to crack an operating system of a user terminal to acquire the highest authority, thereby achieving beneficial effects of improving system security.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 illustrates a flow chart of a privacy authority management method according to the disclosure;

FIG. 2 illustrates a block diagram of a privacy authority management device according to the disclosure;

FIG. 3 illustrates a block diagram of an intelligent electronic apparatus for executing the method according the disclosure; and

FIG. 4 illustrates a schematic diagram of a memory cell which is used to store or carry program codes for realizing the method according to the disclosure.

### DESCRIPTION OF THE EMBODIMENTS

Exemplary embodiments of the disclosure will be described in detail with reference to the accompanying figures hereinafter. Although the exemplary embodiments of the disclosure are illustrated in the accompanying figures, it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

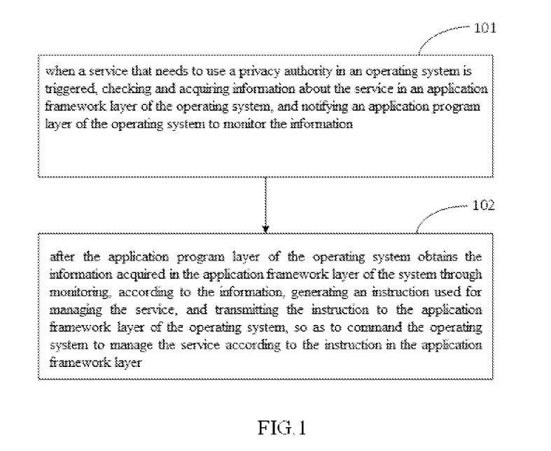

With reference to FIG. 1, it illustrates a flow chart of a first method embodiment of privacy authority management according to an embodiment of the disclosure. In this embodiment, by way of an intelligent terminal installed with Android system, the principle of the disclosure will be exemplarily described. However, the description herein is merely illustrative and the scope of the disclosure is not limited thereto. The principle of the disclosure is also suitable for an intelligent terminal installed with other operating system (such as, Linux, iOS, Windows Phone, Symbian, etc,).

In this embodiment, the method may particularly include steps of:

Step 101: when a service that needs to use a privacy authority in an operating system is triggered, checking and acquiring information about the service in an application framework layer of the operating system, and notifying an application program layer of the operating system to monitor to the information.

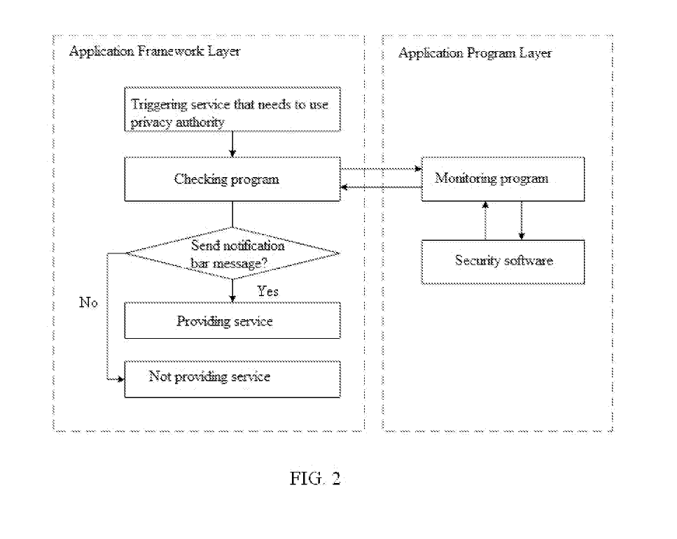

For the operating system of the intelligent terminal, an application program normally comprises an application framework layer and an application program layer, with reference to FIG. 2. By way of android system as an example, some information in the system framework layer is not available by the application program layer in the prior art. For example, in Android system in the prior art, information about a service that uses a privacy authority in the system framework layer is not available by software on the application program layer side, i.e., it is not available by third-party software (for example, third-party security software). Therefore, when a service in the system is triggered, the third-party software cannot manage a sending process of the information by a privilege escalation. The privilege escalation may include “root”, “jailbreak”, for example.

In the disclosure, the process of the service that needs to use the privacy authority in the application framework layer of the operating system is improved. When the service that needs to use the privacy authority is triggered in the operating system, the application framework layer of the operating system may check the triggered service and acquire the information the service.

By way of a text to be sent in the system as an example, when a service that needs to send the text in the system is triggered, the application framework layer of the operating system in the prior art may acquire information about the service that needs to send the text by sendText( ) and sendMultipartText( ) methods in an IccSmsInterfacemanager class.

However, there are no methods in the IccSmsInterfacemanager class to transmit the content to the application program layer of the system. Therefore, the program of the application framework layer of Android operating system in the prior art cannot transmit the content of the send-text service to the application program layer of the system.

In the disclosure, a checking program is set in the application framework layer in the operating system to realize to read the information about the service and transmit it to the application program layer of the operating system. Since the checking program is located in the process of the application framework layer of the operating system, it inherently has such a privilege, i.e., a privilege of acquiring the information about the service that needs to use the privacy authority in the application framework layer of the operating system.

In the disclosure, when the service that needs for the privacy authority in the application framework layer of the system is triggered, steps that provide or do not provide the service will not be directly entered, but first the checking program set in the application framework layer of the operating system will check and acquire the information about the service. The checking program may be used to perform a privacy authority management of the actual system by adding a system service named SecurityService to the Android system. In the SecurityService, a checkPrivilege( ) method may be used to realize the above function.

In the meanwhile, since the sendText( ) and sendMultipartText( ) methods in the IccSmsInterfacemanager class has acquired the information about the service when the service that needs to use the privacy authority in the Android system is triggered, the checking program merely needs to read the information from the IccSmsInterfacemanager class.

According to another example of the disclosure, when a service that needs to make a call is triggered, the system service named SecurityService in the Android system may also used to perform the privacy authority management of the actual system. In the SecurityService, the checkPrivilege( ) method may be used to check relevant information about the make-call service.

In addition to the send-text service and the make-call service as illustrated above, other services in the system, such as obtaining phone numbers, reading call records, reading texts, writing call records, writing contacts, reading precise position, reading rough position, recording audio, opening camera, switching on WiFi, switching on Bluetooth, reading a list of installed applications, obtaining device ID and other possible services in relation to private data, may check and read the information about the services by setting the checking program.

The information may preferably contain information of an application requesting for the service that needs to use the privacy authority and the specific contents of the service. Of course, it would be understood that the checking program may also acquire all the relevant contents in relation to the service in the application framework layer of the operating system. The acquisition of different contents provides a basis for the security software to set specific processing rules.

With reference to FIG. 2, since the checking program is located in the application framework layer of the system and inherently has the privilege to acquire the information of the application framework layer of the operating system, it may acquire the information about the service that needs to use the privacy authority in the system without the privilege escalation by the user.

Preferably, the checking program may check all the triggered services that need to use the privacy authority in the system. These services include but are not limited to: making a call, sending a text, obtaining phone numbers, reading call records, reading texts, writing call records, writing contacts, reading precise position, reading rough position, recording audio, opening camera, switching on WiFi, switching on Bluetooth, reading a list of installed applications, obtaining device ID and other possible interfaces in relation to private data. In such manner, all the services in relation to the privacy authority in the system may be monitored to improve the security.

Of course, it is also possible to set checking rules, and merely some of applications within the rules are checked. For example, a checking is made to the precise position but not to the rough position. In other words, a checking is made to a service having a high privacy level but not to service having a low privacy level. In such a manner, it is possible to improve checking efficiency and user experience while guaranteeing the security of user's privacy.

After the checking program checks the triggered service and acquire the information thereof, it may notify the application program layer of the operating system to receive the information. In particular, the notification may be achieved by a notification function. In other words, a monitor unit is provided, in which a notification function is provided. After the checking program checks and acquire the information about the service, the checking program may invoke the notification function to notify the application program layer of the system to monitor to acquire the information. The notification function is located in the application program layer of the system, with reference to FIG. 2. In such a manner, it is possible to realize to transmit the information of the service checked by the checking program out of the application framework layer of the operating system.

Next, Step 102, after the application program layer of the operating system obtains the information acquired in the application framework layer of the system through monitoring, according to the information, generating an instruction used for managing the service, and transmitting the instruction to the application framework layer of the operating system, so as to command the operating system to manage the service according to the instruction in the application framework layer.

The monitoring procedure may achieved by assigning a QihooPrivilegeMonitor interface in the application program layer of the operating system. The interface may use a boolean CheckPrivilege (String packageName, int uid, int pid, int privilege, Bundle info) method to achieve the acquisition of relevant information of the service in the application program layer of the operating system. After the checking program checks and reads the information of the service that needs to use the privacy authority, it may invoke above function in a monitor to transmit the information to the security software in the application program layer of the system.

The monitor unit may be set by registering a privacy authority service monitor into the system.

In particular, a privacy authority service control class, such as, a QihooAppManager class may be provided. The class uses setPrivilegeMonitor (QihooPrivilegeMonitor monitor) method to register the privacy authority service monitor into the system. The monitor may contain the notification function. After the security software in the application program layer of the operating system registers the privacy authority service monitor into the operating system, the checking program in the application framework layer of the operating system is able to automatically invoke the notification function to notify the security software upon the acquisition of the information about the privacy authority service, and further to notify the application program layer of the operating system to monitor the information.

In the view of this, by providing the monitoring program, the information in the application framework layer of the operating system can be transmitted to the application program layer of the system. Therefore the security software in the application program layer of the operating system can monitor to the information in the application framework layer of the operating system without privilege escalation.

In above setting manner, it is also possible to conveniently and promptly transmit the data to the security software. When no privacy authority service in the system is triggered, the monitoring is not necessarily activated so that no resource is occupied. However, once the service that needs to use the privacy authority in the system is triggered, it is possible to obtain the information about the privacy authority service through monitoring.

In the meanwhile, such invoking and monitoring manners are used, such that the checking program in the application framework layer of the operating system can communicate only by the specific monitor. This may avoid the information in the application framework layer of the operating system from leakage, thereby improving the security of information. Other malicious software cannot use the information about the privacy authority service to threaten the user.

Further, communication rules between the security software and the monitoring program may be set such that the monitoring program can communicate only with the preset security software. This may avoid the malicious software pretending the security software to use the information about the privacy authority service, resulting in an information leakage.

Once the security software receives the information about the privacy authority service, relevant security processing may be made according to the information.

For example, in a preferred embodiment of the disclosure, the security software in the intelligent terminal may parse the application in relation to the triggering of the privacy authority service in the information. When it is detected a malicious application triggers the service, the security software may reject the service and send a prompt message to inform the user.

As another aspect, for system privacy authority services triggered by built-in system applications of Android system, such as applications of making a call, sending a text, switching on WiFi, etc, triggered by Android system, the services may be automatically allowable. Since these functions are very common functions for the user and the services triggered by the built-in applications of the system usually have no malicious features, it is possible to reduce interference with the normal use of the mobile terminal by the user, improving user experience.

According to another aspect of the disclosure, in the case that a service is initiated neither by the malicious application recognized by the security software nor by the built-in applications of the system, the security software may pop up a dialog box to notify the user to choose whether or not to allow for the service. The command for managing the privacy authority service may be generated according to the user's choice.

In such a manner, the user may automatically choose the authorization for access to the private data, avoiding the private data from being obtained by the malicious software or avoiding backstage automatically invoking the service to result in the privacy leakage and/or the loss of resource.

Of course, after receiving the information about the service, the security software may not judge whether it is initiated by the malicious program but present it to the user, further to lead the user to manage the privacy authority services. Such a prompt may be provided by a pop-up box, or popped up according to the user's choice when the user invokes the privacy authority management function of the security software. After the user indicates whether or not to allow for the privacy authority service according to the information about the service, the security software may generate an instruction of whether or not to allow the application framework layer of the operating system to provide the service according to the user's indication.

Being generated, the instruction is transmitted to the application framework layer of the operating system, so as to command the operating system manage the service that needs to use privacy authority in the application framework layer according to the instruction. The instruction may be transmitted to the operating system in many ways. In other words, any suitable ways of transmitting information within the operating system may be used.

In a preferred embodiment of the disclosure, following transmission may be used. Once the instruction is generated, the contents of the instruction may be returned to the checking program through the notification function of the monitor.

As stated above, by providing the monitor, it is possible to conveniently and promptly transmit the data back to the checking program. In the meanwhile, it is possible set the monitor to communicate only with the specific security software. In such a manner, other malicious applications could not fabricate an instruction to threaten the user.

It should be explained that, in the step of returning the instruction to the application framework layer of the operating system, the instruction may be set such that it is not received by the checking program, but instead received by an additional judgment module. Upon the receipt of the instruction, the judgment module may control the application framework layer of the operating system to enable or disable the service that needs the privacy authority.

With the completion of above operation, the instruction may be executed in the application framework layer of the operating system. When the instruction sent from the security software allows for the service, the system may execute the instruction to provide the service; and when the instruction sent from the security software does not allow for the service, the system may execute the instruction to disable the service, with reference to FIG. 2.

In a preferred manner, the security software may return the instruction in the form of a returned value. In other words, “true” refers to an operation for enabling the service, and “false” refers to an operation for disabling the service. The instruction may be transmitted to a service execution unit through the checking program. When the instruction is “true”, the service execution unit may execute the service; and when the instruction is “false”, the service execution unit may not be activated so as not to execute the service.

Algorithm and display provided herein are not inherently related to a particular computer, virtual system or other equipment. Various general systems may also be used with the teaching based on the disclosure. According to the above description, the required structure for constructing such a system is obvious. In addition, the disclosure is not directed to any specific programming language. It should be understood that a variety of programming languages can be used to implement the disclosed contents as described herein and above description to the specific programming language is used to disclose the best inventive implementation mode.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the disclosure, various features of the disclosure may sometimes be grouped together into a single embodiment, accompanying figure or description thereof. However, the method of this disclosure should not be constructed as follows: the disclosure for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the disclosure.

It should be understood by those skilled in the art that modules of the apparatus in the embodiments can be adaptively modified and arranged in one or more apparatuses different from the embodiment. Modules in the embodiment can be combined into one module, unit or component, and also can be divided into more sub-modules, sub-units or sub-components. Except that at least some of features and/or processes or modules are mutually exclusive, various combinations can be used to combine all the features disclosed in specification (including appended claims, abstract and accompanying figures) and all the processes or units of any methods or devices as disclosed herein. Unless otherwise definitely stated, each of features disclosed in specification (including appended claims, abstract and accompanying figures) may be taken place with an alternative feature providing same, equivalent or similar purpose.

In addition, it should be understood by those skilled in the art, although some embodiments as discussed herein comprise some features included in other embodiment rather than other feature, combination of features in different embodiment means that the combination is within a scope of the disclosure and forms the different embodiment. For example, in the claims, any one of the embodiments for which the protection is sought can be used in any combined manners.

Each of components according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the components in the privacy authority management device according to the embodiments of the disclosure. The disclosure may further be implemented as apparatus or device program (for example, computer program and computer program product) for executing some or all of the methods as described herein. Such program for implementing the disclosure may be stored in the computer readable medium, or have a form of one or more signals. Such a signal may be downloaded from the Internet websites, or be provided in carrier, or be provided in other manners.

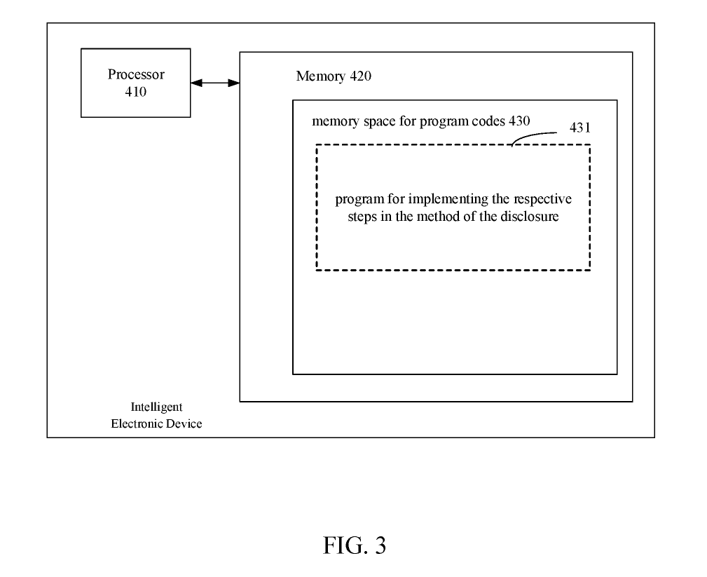

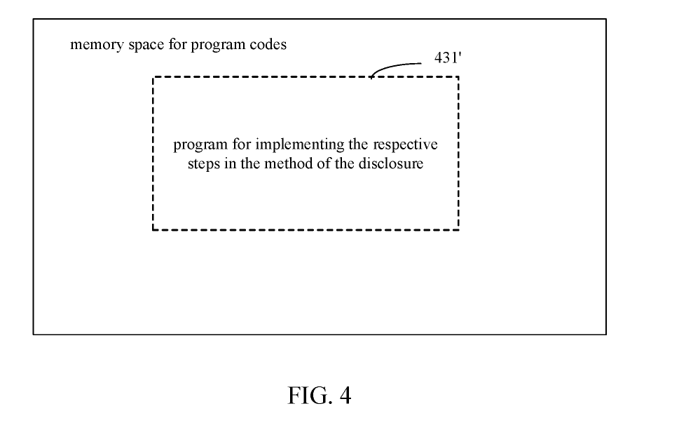

For example, FIG. 3 illustrates an intelligent electronic apparatus which may implement the privacy authority management method according to this disclosure. Traditionally, the intelligent electronic apparatus includes a processor 410 and a computer program product or a computer readable medium in form of a memory 420. The memory 420 could be electronic memories such as flash memory, EEPROM (Electrically Erasable Programmable Read—Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 4. The memory cells may be provided with memory sections, memory spaces, etc., similar to the memory 420 of the intelligent electronic apparatus as shown in FIG. 3. The program codes may be compressed for example in an appropriate form. Usually, the memory cell includes a program 431′ for executing the method steps according to the disclosure, which could be codes readable for example by processors 410. When these codes are operated on the intelligent electronic apparatus, the communication device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims. Disclosed herein is A1. A privacy authority management method, comprising:

when a service that needs to use a privacy authority in an operating system is triggered, checking and acquiring information about the service in an application framework layer of the operating system, and notifying an application program layer of the operating system to monitor to the information; and

after the application program layer of the operating system obtains the information acquired in the application framework layer of the system through monitoring, according to the information, generating an instruction used for managing the service, and transmitting the instruction to the application framework layer of the operating system, so as to command the operating system to manage the service according to the instruction in the application framework layer.

A2. The method according to A1, characterized in that, the step of checking the service in the application framework layer of the operating system comprises: checking all the triggered services that need to use the privacy authority in the system.

A3. The method according to A1, characterized in that, the service that needs to use the privacy authority comprises one or more service of making a call, sending a text, obtaining phone numbers, reading call records, reading texts, writing call records, writing contacts, reading precise position, reading rough position, recording audio, opening camera, switching on WiFi, switching on Bluetooth, reading a list of installed applications, and obtaining device ID.

A4. The method according to any one of A1-A3, characterized in that, the step of the application program layer of the operating system obtaining the information acquired in the application framework layer of the system through monitoring, comprises: by invoking a notification function in the application program layer of the operating system, the application framework layer of the operating system communicating with the application program layer of the operating system, so as to monitor to the information in the application program layer of the operating system; and

the step of transmitting the instruction to the application framework layer of the operating system, comprises: by invoking the notification function, the application program layer of the operating system communicating with the application framework layer of the operating system, so as to return the obtained instruction through monitoring the application framework layer of the operating system.

A5. The method according to A1, characterized in that, the information comprises information of an application triggering the service that needs to use the privacy authority and/or contents of the service itself.

A6. The method according to A1 or A5, characterized in that, the step of, according to the information, generating an instruction used for managing the service, comprises: analyzing the relevant contents by preset rules and automatically generating an instruction of whether or not to allow for providing the service, wherein the rules are able to be set and/or updated by the user.

A7. The method according to A1 or A5, characterized in that, the step of, according to the information, generating an instruction used for managing the service, comprises: parsing the information of the application triggering the service that needs to use privacy authority; when it is detected that a malicious application triggers the service, prohibiting providing the service; and when it is detected that a credible application triggers the service, allowing for providing the service.

A8. The method according to A1 or A5, characterized in that, the step of, according to the information, generating an instruction used for managing the service, comprises: presenting the information to the user, allowing the user to choose whether or not to provide the service according to the information contents, and generating an instruction of whether or not to provide the service according to the user's choice.

B9. A privacy authority management device, comprising:

a privacy service checking unit, configured to, when a service that needs to use a privacy authority in an operating system is triggered, check and acquire information about the service in an application framework layer of the operating system, and notify an application program layer of the operating system to monitor to the information; and

a security software unit, configured to, after the application program layer of the operating system obtains the information acquired in the application framework layer of the system through monitoring, according to the information, generate an instruction used for managing the service, and transmit the instruction to the application framework layer of the operating system, so as to command the operating system to manage the service according to the instruction in the application framework layer.

B10. The device according to B9, characterized in that, the checking of the service in the application framework layer of the operating system comprises: the checking of all the triggered services that need to use the privacy authority in the system.

B11. The device according to B9, characterized in that, the service that needs to use the privacy authority comprises one or more service of making a call, sending a text, obtaining phone numbers, reading call records, reading texts, writing call records, writing contacts, reading precise position, reading rough position, recording audio, opening camera, switching on WiFi, switching on Bluetooth, reading a list of installed applications, and obtaining device ID.

B12. The device according to any one of B9-B11, characterized in that, the application program layer of the operating system obtaining the information acquired in the application framework layer of the system through monitoring, comprises: by invoking a notification function in the application program layer of the operating system, the application framework layer of the operating system communicates with the application program layer of the operating system, so as to monitor to the information in the application program layer of the operating system; and

the transmission of the instruction to the application framework layer of the operating system, comprises: by invoking the notification function, the application program layer of the operating system communicates with the application framework layer of the operating system, so as to return the obtained instruction through monitoring the application framework layer of the operating system.

B13. The device according to B9, characterized in that, the information comprises information of an application triggering the service that needs to use the privacy authority and/or contents of the service itself.

B14. The device according to B9 or B13, characterized in that, the generation of an instruction used for managing the service according to the information, comprises: the device analyzes the relevant contents by preset rules and automatically generates an instruction of whether or not to allow for providing the service, wherein the rules are able to be set and/or updated by the user.

B15. The device according to B9 or B13, characterized in that, the generation of an instruction used for managing the service according to the information, comprises: the device parses the information of the application triggering the service that needs to use privacy authority; when it is detected that a malicious application triggers the service, prohibits providing the service; and when it is detected that a credible application triggers the service, allows for providing the service.

B16. The device according to B9 or B13, characterized in that, the generation of an instruction used for managing the service according to the information, comprises: the device presents the information to the user, allows the user to choose whether or not to provide the service according to the information contents, and generates an instruction of whether or not to provide the service according to the user's choice.

1. A privacy authority management method, comprising:
when a service that needs to use a privacy authority in an operating system is triggered, checking and acquiring information about the service in an application framework layer of the operating system, and notifying an application program layer of the operating system to monitor to the information; and
after the application program layer of the operating system obtains the information acquired in the application framework layer of the system through monitoring, according to the information, generating an instruction used for managing the service, and transmitting the instruction to the application framework layer of the operating system, so as to command the operating system to manage the service according to the instruction in the application framework layer.

2. The method according to claim 1, characterized in that, the step of checking the service in the application framework layer of the operating system comprises: checking all the triggered services that need to use the privacy authority in the system.

3. The method according to claim 1, characterized in that, the service that needs to use the privacy authority comprises one or more service of making a call, sending a text, obtaining phone numbers, reading call records, reading texts, writing call records, writing contacts, reading precise position, reading rough position, recording audio, opening camera, switching on WiFi, switching on Bluetooth, reading a list of installed applications, and obtaining device ID.

4. The method according to claim 1, characterized in that, the step of the application program layer of the operating system obtaining the information acquired in the application framework layer of the system through monitoring, comprises: by invoking a notification function in the application program layer of the operating system, the application framework layer of the operating system communicating with the application program layer of the operating system, so as to monitor to the information in the application program layer of the operating system; and
the step of transmitting the instruction to the application framework layer of the operating system, comprises: by invoking the notification function, the application program layer of the operating system communicating with the application framework layer of the operating system, so as to return the obtained instruction through monitoring the application framework layer of the operating system.

5. The method according to claim 1, characterized in that, the information comprises information of an application triggering the service that needs to use the privacy authority and/or contents of the service itself.

6. The method according to claim 1, characterized in that, the step of, according to the information, generating an instruction used for managing the service, comprises: analyzing the relevant contents by preset rules and automatically generating an instruction of whether or not to allow for providing the service, wherein the rules are able to be set or updated by the user.

7. The method according to claim 1, characterized in that, the step of, according to the information, generating an instruction used for managing the service, comprises: parsing the information of the application triggering the service that needs to use privacy authority; when it is detected that a malicious application triggers the service, prohibiting providing the service; and when it is detected that a credible application triggers the service, allowing for providing the service.

8. The method according to claim 1, characterized in that, the step of, according to the information, generating an instruction used for managing the service, comprises: presenting the information to the user, allowing the user to choose whether or not to provide the service according to the information contents, and generating an instruction of whether or not to provide the service according to the user's choice.

9. An intelligent mobile device for privacy authority management, comprising:
a memory having instructions stored thereon;
a processor configured to execute the instructions to perform operations for privacy authority Management, comprising:
when a service that needs to use a privacy authority in an operating system is triggered, checking and acquiring information about the service in an application framework layer of the operating system, and notify an application program layer of the operating system to monitor to the information; and
after the application program layer of the operating system obtains the information acquired in the application framework layer of the system through monitoring, according to the information, generating an instruction used for managing the service, and transmitting the instruction to the application framework layer of the operating system, so as to command the operating system to manage the service according to the instruction in the application framework layer.

10. The intelligent mobile device according to claim 9, characterized in that, checking the service in the application framework layer of the operating system comprises: checking all the triggered services that need to use the privacy authority in the system.

11. The intelligent mobile device according to claim 9, characterized in that, the service that needs to use the privacy authority comprises one or more service of making a call, sending a text, obtaining phone numbers, reading call records, reading texts, writing call records, writing contacts, reading precise position, reading rough position, recording audio, opening camera, switching on WiFi, switching on Bluetooth, reading a list of installed applications, and obtaining device ID.

12. The intelligent mobile device according to claim 9, characterized in that, the application program layer of the operating system obtaining the information acquired in the application framework layer of the system through monitoring, comprises: by invoking a notification function in the application program layer of the operating system, the application framework layer of the operating system communicating with the application program layer of the operating system, so as to monitor to the information in the application program layer of the operating system; and
transmitting the instruction to the application framework layer of the operating system, comprises: by invoking the notification function, the application program layer of the operating system communicating with the application framework layer of the operating system, so as to return the obtained instruction through monitoring the application framework layer of the operating system.

13. The intelligent mobile device according to claim 9, characterized in that, the information comprises information of an application triggering the service that needs to use the privacy authority and/or contents of the service itself.

14. The intelligent mobile device according to claim 9, characterized in that, generating an instruction used for managing the service according to the information, comprises: analyzing the relevant contents by preset rules and automatically generating an instruction of whether or not to allow for providing the service, wherein the rules are able to be set or updated by the user.

15. The intelligent mobile device according to claim 9, generating an instruction used for managing the service according to the information, comprises: parsing the information of the application triggering the service that needs to use privacy authority; when it is detected that a malicious application triggers the service, prohibits providing the service; and when it is detected that a credible application triggers the service, allowing for providing the service.

16. The intelligent mobile device according to claim 9, characterized in that, generating an instruction used for managing the service according to the information, comprises: presenting the information to the user, allowing the user to choose whether or not to provide the service according to the information contents, and generates an instruction of whether or not to provide the service according to the user's choice.

17. (canceled)

18. A non-transitory computer readable medium, having computer programs stored thereon that, when executed by one or more processors of an intelligent mobile device, cause the intelligent mobile device to perform:
when a service that needs to use a privacy authority in an operating system is triggered, checking and acquiring information about, the service in an application framework layer of the operating system, and notifying an application program layer of the operating system to monitor to the information; and
after the application program layer of the operating system obtains the information acquired in the application framework layer of the system through monitoring, according to the information, generating an instruction used for managing the service, and transmitting the instruction to the application framework layer of the operating system, so as to command the layer.
